(19) United States
(12) Patent Application Publication
(10) Pub. No.: US 2017/0175916 A1
(43) Pub. Date: Jun. 22, 2017

(54) SPOOL ASSEMBLY FOR CONTROL VALVE

(71) Applicant: EATON CORPORATION, CLEVELAND, OH (US)

(72) Inventors: Tam Chi Huynh, Richfield, MN (US); Chris William Schottler, Chanhassen, MN (US)

(21) Appl. No.: 15/300,006

(22) PCT Filed: Mar. 27, 2015
(86) PCT No.: PCT/US15/22897

§ 371 Date: Sep. 28, 2016

Related U.S. Application Data
(60) Provisional application No. 61/972,733, filed on Mar. 31, 2014.

(51) Int. Cl. F16K 31/06; F16K 11/07; F15B 13/044; F16K 31/08

(52) U.S. Cl. CPC F16K 31/0613; F16K 31/082; F16K 11/0716; F15B 13/0446

(57) ABSTRACT

The control valve assembly includes a valve housing defining a bore and a valve assembly. The valve assembly includes a spool assembly disposed in the bore of the valve housing. The spool assembly includes a first spool and a second spool. The first spool has a first axial end and an oppositely disposed second axial end. The first spool is made of a first material. The first material is non-magnetic. The second spool has a first end and an oppositely disposed second end. The first end of the second spool is engaged to the second axial end of the first spool. The second spool is made of a second material. The second material is magnetic.

### CROSS-REFERENCE TO RELATED APPLICATION

This application is being filed on 27 Mar. 2015 as a PCT International Patent Application and claims priority to U.S. Patent Application Ser. No. 61/972,733 filed on 31 Mar. 2014, the disclosure of which is hereby incorporated herein by reference in its entirety.

### BACKGROUND

Control valves are used in hydraulic systems for controlling hydraulic fluid flow. In one embodiment, the control valve includes a spool that is moved within a corresponding spool bore of the control valve to alternatingly place a work port of the control valve in fluid communication with either a fluid inlet or a fluid outlet.

While control valves are used in many applications, the components of the valve can be difficult to manufacture. Therefore, there is a need to provide a robust design of a control valve that improves manufacturability of the valve.

### SUMMARY

An aspect of the present disclosure relates to a control valve assembly. The control valve assembly includes a valve housing defining a bore and a valve assembly. The valve assembly includes a spool assembly disposed in the bore of the valve housing. The spool assembly includes a first spool and a second spool. The first spool has a first axial end and an oppositely disposed second axial end. The first spool is made of a first material. The first material is non-magnetic. The second spool has a first end and an oppositely disposed second end. The first end of the second spool is engaged to the second axial end of the first spool. The second spool is made of a second material. The second material is magnetic.

Another aspect of the present disclosure relates to a valve assembly. The valves assembly includes a voice coil assembly and a spool assembly connectedly engaged with the voice coil assembly. The voice coil assembly includes a permanent magnet, a pole piece and a bobbin. The spool valve assembly includes a first spool and a second spool. The first spool has a first axial end and an oppositely disposed second axial end. The first spool is made of a first material. The second spool has a first end and an oppositely disposed second end. The first end of the second spool is engaged with the second axial end of the first spool. The second spool is made of a second material. The second material is different than the first material.

Another aspect of the present disclosure relates to a valve assembly. The valve assembly includes a voice coil assembly and a spool assembly connectedly engaged with the voice coil assembly. The voice coil assembly includes a permanent magnet, a pole piece and a bobbin. The spool valve assembly includes a first spool and a second spool. The first spool has a first axial end and an oppositely disposed second axial end. The first spool is made of a first material. The second spool has a first end and an oppositely disposed second end. The first end of the second spool is engaged with the second axial end of the first spool. The second spool is made of a second material. The second material is different than the first material. The second material is magnetic and has a hardness value that is greater than a hardness value of the first material.

### DRAWINGS

FIG. 1 is a cross-sectional view of a control valve assembly having exemplary features of aspects in accordance with the principles of the present disclosure.

FIG. 2 is a perspective view of a spool valve assembly suitable for use in the control valve assembly of FIG. 1.

FIG. 3 is an exploded perspective view of the spool valve assembly of FIG. 2.

FIG. 4 is a cross-sectional view of the spool valve assembly of FIG. 2.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

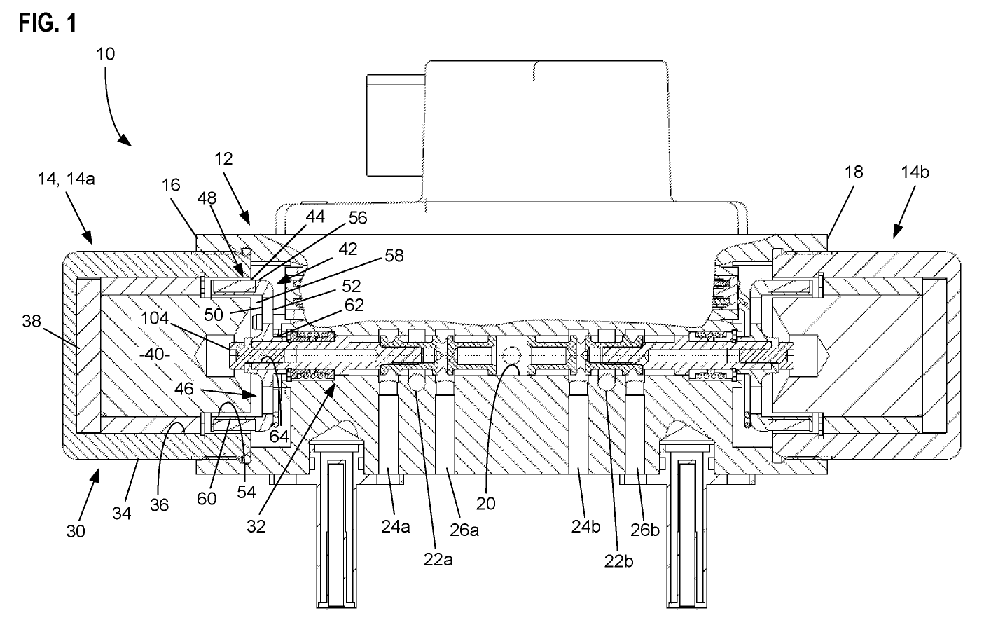

Referring now to FIG. 1, a control valve assembly 10 for use in a fluid system is shown. In the depicted embodiment, the control valve assembly 10 is a proportional directional control valve assembly. The control valve assembly 10 includes a valve housing 12 and a valve assembly 14. In the depicted embodiment, the control valve assembly 10 includes a first valve assembly 14a and a second valve assembly 14b.

The valve housing 12 includes a first end 16 and an oppositely disposed second end 18. The valve housing 12 defines a bore 20. In the depicted embodiment, the bore 20 extends through the first and second ends 16, 18 of the valve housing 12.

The housing further defines a fluid inlet passage 22, a return passage (not shown), a first pilot passage 24a and a second pilot passage 26a. Each of the fluid inlet passage 22, the return passage, and the first and second pilot passages 24, 26 is in fluid communication with the bore 20 of the valve housing 12. In the depicted embodiment, the housing 12 defines a first fluid inlet passage 22a, a second fluid inlet passage 22b, a first return passage (not shown), a second return passage (not shown), a first pilot passage 24a, a second pilot passage 24b, a third pilot passage 26a and a fourth pilot passage 26b.

In the depicted embodiment, the first valve assembly 14a controls fluid communication between the first fluid inlet passage 22a and the first return passage and the first and second pilot passages 24a, 26a. The second valve assembly 14b controls fluid communication between the second fluid inlet 22b and the second return passage and the third and fourth pilot passages 24b, 26b. In the depicted embodiment, the first and second valve assemblies 14a, 14b are substantially similar. Therefore, for ease of description purposes only, each of the first and second valve assemblies 14a, 14b will be referred to as the valve assembly 14.

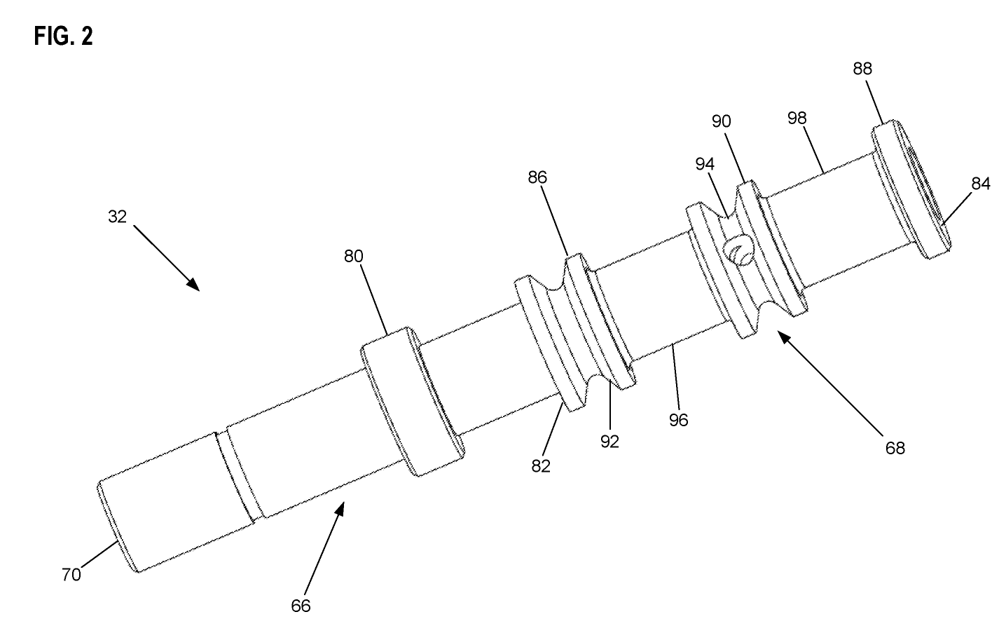

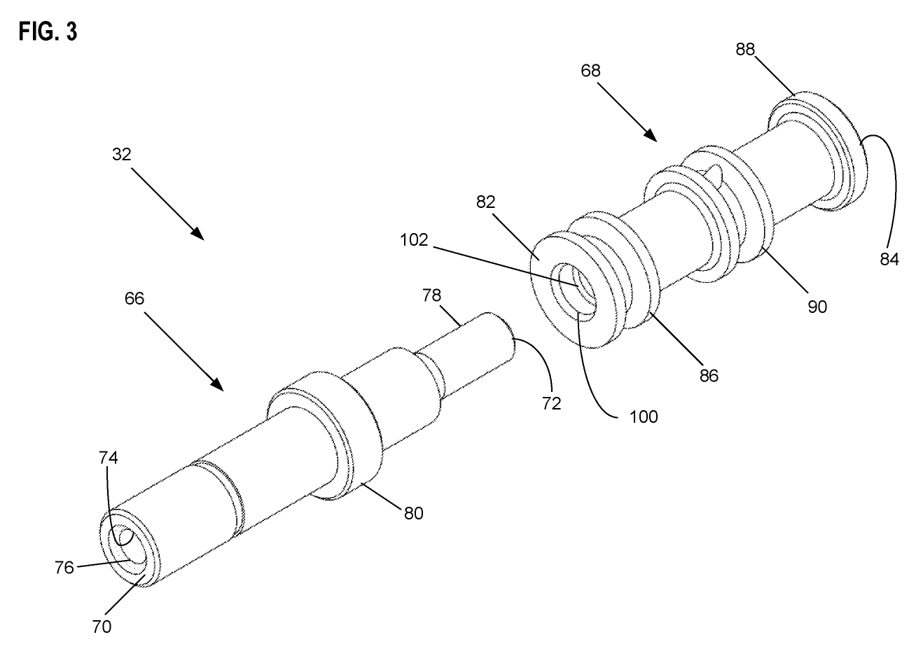

Referring still to FIGS. 1-3, the valve assembly 14 is a proportional valve assembly. The valve assembly 14 includes a voice coil assembly 30 and a spool assembly 32.

The voice coil assembly 30 includes a cover 34. The cover 34 defines an interior 36. The voice coil assembly 30 further includes a permanent magnet 38 and a pole piece 40. The permanent magnet 38 and the pole piece 40 are disposed in the interior 36 of the cover 34.

The voice coil assembly 30 further includes a bobbin 42 and a coil winding 44. The bobbin 42 includes a base 46 and a sidewall 48. The base 46 includes a first surface 50 and an oppositely disposed second surface 52.

The sidewall 48 is generally cylindrical in shape. The sidewall 48 extends outwardly from the first surface 50 of the base 46. The sidewall 48 includes an inner surface 54 and an oppositely disposed outer surface 56.

In the depicted embodiment, the first surface 50 of the base 46 and the inner surface 54 of the sidewall 50 cooperatively define a cavity 58. In the depicted embodiment, at least a portion of the pole piece 40 is disposed in the cavity 58.

The outer surface 56 of the sidewall 48 defines a coil groove 60 that extends annularly around the bobbin 42. The coil winding 44 is disposed about the outer surface 56 of the sidewall 48. In the depicted embodiment, the coil winding 44 is disposed in the coil groove 60 of the sidewall 48.

In the depicted embodiment, the bobbin 42 includes a collar 62 that extends outwardly from the second surface 52 of the base 46. In the depicted embodiment, the collar 62 is centered along the base 46 of the bobbin 42. The collar 62 defines an inner bore 64. In the depicted embodiment, a portion of the spool assembly 32 is disposed in the inner bore 64 of the collar 62 of the bobbin 42.

Referring now to FIGS. 1-3, the spool assembly 32 will be described. The spool assembly 32 is adapted to selectively reciprocate in the bore 20 of the valve housing 12 in response to actuation of the voice coil assembly 30. The spool assembly 32 includes a first spool 66 and a second spool 68.

The first spool 66 includes a first axial end 70 and an oppositely disposed second axial end 72. In the depicted embodiment, the first axial end 70 includes an inner bore 74. The inner bore 74 includes a plurality of internal threads 76 disposed adjacent to the first axial end 70. In the depicted embodiment, the second axial end 72 includes a plurality of external threads 78.

In the depicted embodiment, the first spool 66 further includes a land 80 disposed between the first and second axial ends 70, 72. The land 80 has an outer diameter that is greater than an outer diameter of the first axial end 70.

The first spool 66 is made of a first material. The first material is a non-magnetic material. In one embodiment, the first material of the first spool 66 is made of a non-magnetic stainless steel material. In one embodiment, the first material has a hardness value in a range of 20 to 30 on the Rockwell C scale (HRC). In another embodiment, the first material has a hardness value in a range of 23 to 27 HRC. In another embodiment, the first material has a hardness value in a range of 24 to 25 HRC.

The second spool 68 includes a first end 82 and an oppositely disposed second end 84. The second spool 68 includes a first land 86 disposed adjacent to the first end 82, a second land 88 disposed adjacent to the second end 84 and a third land 90 disposed between the first and second lands 86, 88. In the depicted embodiment, the first land 86 includes a first groove 92. The first groove 92 is an annular groove. In the depicted embodiment, the first groove 92 is centrally disposed in the first land 86.

In the depicted embodiment, the third land 90 includes a second groove 94. The second groove 94 is an annular groove. In the depicted embodiment, the second groove 94 is centrally disposed in the third land 90. The first and second grooves 92, 94 are configured to pressure balance the second spool 68 in the bore 20 of the valve housing 12.

The second spool 68 defines a first fluid passage 96 disposed between the first and third lands 86, 90 and a second fluid passage 98 disposed between the second and third lands 88, 90. In the depicted embodiment, the first and second passages 96, 98 are annular grooves. Outer diameters of the first and second passages 96, 98 are less than outer diameters of the first, second and third lands 86, 88, 90.

The first end 82 of the second spool 68 defines an interior bore 100. In the depicted embodiment, the interior bore 100 defines a plurality of internal threads 102.

The second spool 68 is made of a second material that is different than the first material. The second material of the second spool 68 is a magnetic material. In the depicted embodiment, the second material is a magnetic steel material.

The second spool 68 has a hardness value that is greater than the hardness value of the first spool 66 of the spool assembly 32. In one embodiment, the second material has a hardness value in a range of 52-62 HRC. In one embodiment, the second material is hardened using a conventional heat-treatment process.

The second axial end 72 of the first spool 66 is engaged to the first end 82 of the second spool 68. In the depicted embodiment, the plurality of external threads 78 of the second axial end 72 of the first spool 68 is threadedly engaged with the plurality of internal threads 102 of the first end 82 of the second spool 68.

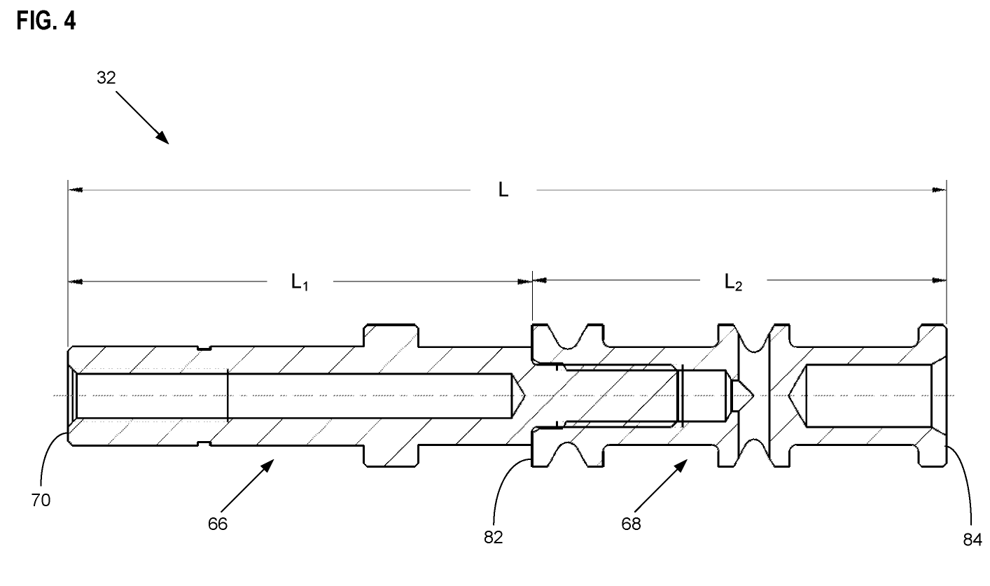

Referring now to FIG. 4, the spool assembly 32 has an overall length L. The overall length L of the spool assembly 32 is measured in an axial direction from the first axial end 70 of the first spool 66 to the second end 84 of the second spool 68. The first spool 66 includes a first length L₁. In the depicted embodiment, the first length L₁ is measured from the first axial end 70 of the first spool 66 to a location 106 at which the first spool 66 abuts the first end 82 of the second spool 68. The second spool 68 includes a second length L₂. In the depicted embodiment, the second length L₂ is measured in an axial direction from the first end 82 to the second end 84 of the second spool 68. The overall length L of the spool assembly 32 is equal to the summation of the first and second lengths L₁, L₂ of the first and second spools 66, 68, respectively.

In one embodiment, the first length L₁ is greater than about 30% of the overall length L of the spool assembly 32. In another embodiment, the first length L₁ is about 35% to about 60% of the overall length L of the spool assembly 32. In another embodiment, the first length L1 is about 40 to about 55% of the overall length L of the spool assembly 32.

The bobbin 42 is engaged to the first axial end 70 of the first spool 66. In the depicted embodiment, the collar 62 of the bobbin 42 is fastened to the first axial end 70 of the first spool 66. In the depicted embodiment, a fastener 104 engages the collar 62 of the bobbin 42 to the first axial end 70 of the first spool 66.

As the first spool 66 is made of a non-magnetic material, the positioning of the first spool 66 of the spool assembly 32 immediately adjacent to the bobbin 42 prevents the spool assembly 32 from being magnetically attracted to the permanent magnet 38 of the voice coil assembly 30. This positioning of the first spool 66 immediately adjacent to the bobbin 42 allows the axial position of the spool assembly 32 in the bore 20 of the valve housing 12 to be unaffected by a magnetic attraction of the permanent magnet 38 of the voice coil assembly 30 and the spool assembly 32.

In operation, the coil winding 44 is activated or energized so that the bobbin 42 is either attracted to the permanent magnet 38 or repelled from the permanent magnet 38. This movement of the bobbin 42 actuates the spool assembly 32 to establish fluid communication between the fluid inlet passage 22 or the return passage with the first or second pilot passages 24, 26. As provided above, the non-magnetic first material of the first spool 66 prevents the spool assembly 32 from being magnetically attracted to the permanent magnet 38 of the voice coil assembly 30, which prevents the spool assembly 32 from being actuated erroneously. The increased hardness value of the second material of the second spool 68 of the spool assembly 32 allows for a more robust spool assembly with increased wear resistance.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

1. A control valve assembly comprising:
a valve housing defining a bore;
a valve assembly including a spool assembly disposed in the bore of the valve housing, the spool assembly including:
a first spool having a first axial end and an oppositely disposed second axial end, the first spool being made of a first material, wherein the first material is non-magnetic; and
a second spool having a first end and an oppositely disposed second end, the first end of the second spool being engaged to the second axial end of the first spool, the second spool being made of a second material, wherein the second material is magnetic.

2. The control valve assembly of claim 1, wherein the first material has a hardness value in a range of about 20 to 30 HRC.

3. The control valve assembly of claim 2, wherein the second material has a hardness value in a range of about 52 to 60 HRC.

4. The control valve assembly of claim 1, wherein a first length of the first spool measured from the first axial end to a location at which the first spool abuts the second spool is greater than 30% of an overall length of the spool assembly.

5. The control valve assembly of claim 1, wherein a first length of the first spool measured from the first axial end to a location at which the first spool abuts the second spool is in a range of about 35% to about 60% of an overall length of the spool assembly.

6. The control valve assembly of claim 1, wherein the valve assembly further includes a voice coil assembly.

7. The control valve assembly of claim 6, wherein the voice coil assembly includes a permanent magnet and a pole piece.

8. The control valve assembly of claim 7, wherein the voice coil assembly includes a bobbin that is engaged to the spool assembly.

9. A valve assembly comprising:
a voice coil assembly having a permanent magnet, a pole piece and a bobbin; and
a spool assembly connectedly engaged with the voice coil assembly, the spool assembly including:
a first spool having a first axial end and an oppositely disposed second axial end, the first spool being made of a first material; and
a second spool having a first end and an oppositely disposed second end, the first end of the second spool being engaged to the second axial end of the first spool, the second spool being made of a second material, wherein the second material is different than the first material.

10. The valve assembly of claim 9, wherein the second material has a hardness value that is greater than a hardness value of the first material.

11. The valve assembly of claim 9, wherein the first material has a hardness value in a range of about 20 to 30 HRC.

12. The valve assembly of claim 9, wherein the second material has a hardness value in a range of about 52 to 60 HRC.

13. The valve assembly of claim 9, wherein a first length of the first spool measured from the first axial end to a location at which the first spool abuts the second spool is greater than 30% of an overall length of the spool assembly.

14. The valve assembly of claim 9, wherein a first length of the first spool measured from the first axial end to a location at which the first spool abuts the second spool is in a range of about 35% to about 60% of an overall length of the spool assembly.

15. The valve assembly of claim 9, wherein the voice coil assembly includes a coil winding disposed about the bobbin.

16. The valve assembly of claim 9, wherein at least a portion of the pole piece is disposed in a cavity defined by the bobbin.

17. The valve assembly of claim 9, wherein the first material is non-magnetic.

18. A valve assembly comprising:
a voice coil assembly having a permanent magnet, a pole piece and a bobbin; and
a spool assembly connectedly engaged with the voice coil assembly, the spool assembly including:
a first spool having a first axial end and an oppositely disposed second axial end, the first spool being made of a first material; and
a second spool having a first end and an oppositely disposed second end, the first end of the second spool being engaged to the second axial end of the first spool, the second spool being made of a second material that is different than the first material, wherein the second material is magnetic and has a hardness value that is greater than a hardness value of the first material.

19. The valve assembly of claim 18, wherein the hardness value of the first material is in a range of about 20 to 30 HRC.

20. The valve assembly of claim 18, wherein the hardness value of the second material is in a range of about 52 to 60 HRC.
